(19) United States
(12) Patent Application Publication
(10) Pub. No.: US 2015/0036537 A1
(43) Pub. Date: Feb. 5, 2015

(54) METHOD AND APPARATUS FOR DISTRIBUTED ASSOCIATION IN WIRELESS NETWORK

(71) Applicant: Electronics and Telecommunications Research Institute, Daejeon (KR)

(72) Inventors: Yong Sun KIM, Daejeon (KR); Hoyong KANG, Daejeon (KR); In Hwan LEE, Daejeon (KR); Chang Sub SHIN, Daejeon (KR); Cheol Sig PYO, Daejeon (KR)

(73) Assignee: Electronics and Telecommunications Research Institute, Daejeon (KR)

(21) Appl. No.: 14/339,028

(22) Filed: Jul. 23, 2014

(30) Foreign Application Priority Data
Jul. 31, 2013 (KR) 10-2013-0091110

(51) Int. Cl. H04W 60/00; H04W 48/14; H04W 48/10

(52) U.S. Cl. CPC H04W 60/00; H04W 48/10; H04W 48/14
USPC 370/254

(57) ABSTRACT

A method and apparatus having advantages of resolving a phenomenon in which traffic is concentrated on an AP of a wireless network and preventing traffic collision to enhance network efficiency are provided. Thousands or more of nodes included in a wireless network can be connected to the wireless network through a plurality of distributed association nodes, rather than through a single AP, and thus, concentration can be resolved and the wireless network can be effectively operated. Also, by performing distributed association on the basis of a single hop, implementation complexity can be lowered.

### CROSS-REFERENCE TO RELATED APPLICATION

This application claims priority to and the benefit of Korean Patent Application No. 10-2013-0091110 filed in the Korean Intellectual Property Office on Jul. 31, 2013, the entire contents of which are incorporated herein by reference.

### BACKGROUND OF THE INVENTION

(a) Field of the Invention

The present invention relates to a method and apparatus for allowing nodes to associate a wireless network in a distributed manner.

(b) Description of the Related Art

In general, in case of wireless communication such as Wi-Fi, ZigBee, or the like, a contention-based channel occupancy scheme such as a carrier sense multiple access with collision avoidance (CSMA/CA) is used because a single access point (AP) manages a small amount of nodes and coverage thereof is small. However, as nodes are increasingly included in a network and applications requesting QoS, and the like, are increased, the contention-based scheme such as the CSMA/CA has been complemented through time division multiple access (TDMA) in which an AP or a coordinator allocates channels divided by predetermined time units to each node in advance. The channel allocation scheme such as TDMA is highly efficient for a case in which data is periodically generated or an amount of transmission data is equal to or higher than a predetermined level.

However, the channel allocation scheme such as TDMA is inefficient in a sensor network in which a small amount of data is intermittently or aperiodically generated or in a network such as a smart grid. Such inefficiency of the TDMA results from the problem of overhead of channel allocation and an idle channel. That is, in a case in which thousands of nodes are connected to a single AP or a single coordinator, overhead is very large in managing the respective nodes and allocating channels to the respective nodes by the AP or the coordinator.

In the contention-based scheme such as CSMA/CA, when collision occurs during data transmission, each node retransmits data by using a retransmission mechanism. Thus, when numerous nodes are connected to the single AP or coordinator, collisions may propagate to paralyze the network. Also, while numerous nodes are connected to the AP based on the contention-based scheme such as CSMA/CA, an AP concentration phenomenon occurs, degrading network efficiency.

### SUMMARY OF THE INVENTION

The present invention has been made in an effort to provide a method and apparatus having advantages of resolving a phenomenon in which traffic is concentrated on an AP of a wireless network and preventing traffic collision to enhance network efficiency.

An exemplary embodiment of the present invention provides a method for managing a plurality of nodes included in coverage of an access point (AP) in a wireless network. The node managing method includes: determining a distributed association node to perform distributed association among a plurality of nodes; including information regarding the distributed association node in a beacon and broadcast the beacon; and receiving information regarding a node connected to the wireless network through the distributed association node from the distributed association node.

In the node managing method, the determining of a distributed association node may include: determining whether a number of first nodes connected to the wireless network through the AP, among the plurality of nodes, is equal to a first threshold value; and when the number of first nodes is equal to the first threshold value, determining a distributed association node among the plurality of nodes.

In the node managing method, the determining of a distributed association node may include: determining whether a number of second nodes that transmit an association request message to the AP is equal to a second threshold value; and when the number of second nodes is equal to the second threshold value, determining a distributed association node among the plurality of nodes.

The node managing method may further include: receiving an association request message from the first node among the plurality of nodes; and transmitting a response message with respect to the association request message to the first node.

In the node managing method, the response message may include an association ID of the wireless network.

In the node managing method, the determining of a distributed association node may include: determining whether a reception waiting time of the association request message is equal to a third threshold value; and when the reception waiting time is equal to the third threshold value, determining a distributed association node among the plurality of nodes.

In the node managing method, the determining of a distributed association node may include: extracting information regarding distributed association distributed association capability from the association request message; and determining a distributed association node on the basis of the information regarding the distributed association capability.

In the node managing method, the determining of a distributed association node on the basis of the information regarding the distributed association capability may include: recording receive strength of the association request message; and determining a node estimated to be located in the middle region of the coverage on the basis of the receive strength.

The node managing method may further include: after the determining of a distributed association node, transmitting association identification (ID) and an available association ID of the distributed association node to the determined distributed association node.

In the node managing method, a node connected to the wireless network through the distributed association node may associate the wireless network by using the available association ID.

In the node managing method, the receiving may include: periodically receiving a list of nodes connected to the wireless networks through the distributed association node and an allocation status of available association IDs.

Another embodiment of the present invention provides a method for a node to associate a wireless network. The wireless network associating method includes: receiving a beacon broadcast from an access point (AP) included in a wireless network; transmitting a first association request message to the AP; when a first response message with respect to the first association request message is not received from the AP, transmitting a second association request message to a first distributed association node among a plurality of distributed association nodes; and when a second response message with respect to the second association request message is received from the first distributed association node, associating the wireless network through the first distributed association node.

The wireless network associating method may further include: when a second response message is not received from the first distributed association node, transmitting a third association request message to a second distributed association node among the plurality of distributed association nodes; and when a third response message with respect to the third association request message is received from the second distributed association node, associating the wireless network through the second distributed association node.

In the wireless network associating method, the transmitting of the second association request message may include determining the first distributed association node upon recognition of media access control (MAC) addresses of a plurality of distributed association nodes written in a beacon.

In the wireless network associating method, associating of the wireless network may include associating the wireless network through the first distributed association node by using an available association ID included in the second response message.

Yet another embodiment of the present invention provides an access point (AP) device that manages a plurality of nodes included in a wireless network. The AP device includes: a distributed association processor configured to determine a distributed association node to perform distributed association among a plurality of nodes; a transmitter configured to include information regarding the distributed association node in a beacon and broadcast the beacon; and a receiver configured to receive information regarding a node connected to the wireless network through the distributed association node among the plurality of nodes, from the distributed association node.

In the AP device, the receiver may receive an association request message from a first node among the plurality of nodes, and the distributed association processor may extract information regarding distributed association capability from the association request message, and determine a distributed association node on the basis of the information regarding distributed association capability.

In the AP device, the transmitter may transmit a response with respect to the association request message, and the response message may include an association ID of the wireless network.

In the AP device, the distributed association processor may determine a node estimated to be located in the middle region of coverage of the AP device on the basis of receive strength of the association request message, as a distributed association node.

In the AP device, the transmitter may transmit association identification (ID) and an available association ID of the distributed association node to the distributed association node.

### BRIEF DESCRIPTION OF THE DRAWINGS

FIG. 1 is a view illustrating an access point (AP) and a plurality of nodes connected to a network via the AP.

FIG. 2 is a view illustrating an AP according to an embodiment of the present invention.

FIG. 3 is a flowchart illustrating a node management process of an AP according to an embodiment of the present invention.

FIG. 4 is a view illustrating an information element regarding a distributed association node list according to an embodiment of the present invention.

FIG. 5 is a view illustrating an information element regarding a distributed association capability according to an embodiment of the present invention.

FIG. 6 is a view illustrating an information element regarding an association ID according to an embodiment of the present invention.

FIG. 7 is a flowchart illustrating a process of requesting authentication/association by a node according to an embodiment of the present invention.

FIG. 8 is a view illustrating an information element regarding a list of connected nodes according to an embodiment of the present invention.

FIGS. 9A and 9B are views illustrating locations of distributed association nodes in a network according to an embodiment of the present invention.

FIG. 10 is a flowchart illustrating a process of generating a list of distributed association nodes by an AP according to an embodiment of the present invention.

FIG. 11 is a view illustrating nodes connected to a network via the AP and the distributed association nodes according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms such as “-er”, “-or”, and “module” described in the specification mean units for processing at least one function and operation, and can be implemented by hardware components or software components and combinations thereof.

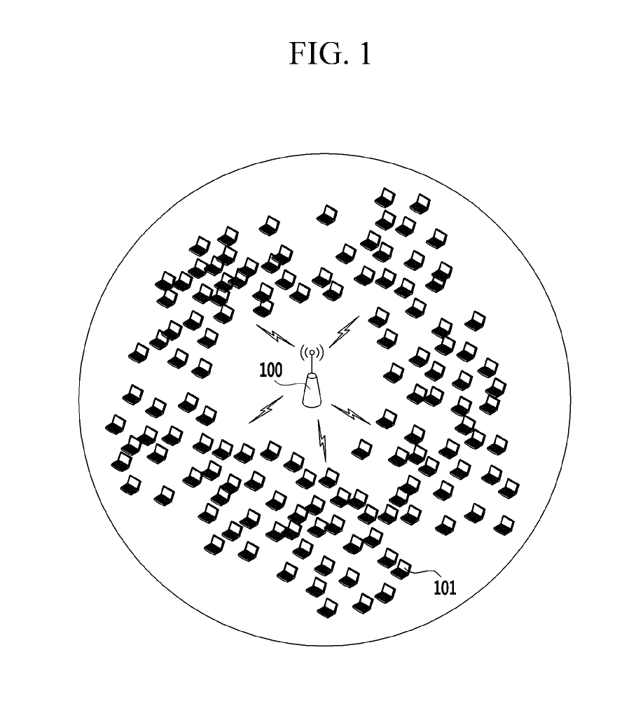

FIG. 1 is a view illustrating an access point (AP) and a plurality of nodes connected to a network via the AP.

Referring to FIG. 1, numerous nodes 101 are connected to coverage of an AP 100. A case in which a Wi-Fi network is used by numerous notebook computers in a conference hall, or the like, may correspond to the illustration of FIG. 1.

However, the numerous nodes included in the coverage of the AP 100 are not equally connected to the network, so nodes located in the vicinity of the boundary of the coverage, among the numerous nodes, may be highly likely to be hidden nodes, relative to the other nodes. That is, there is a high possibility that uplink data transmitted from the nodes located in the vicinity of the boundary of the coverage collide before reaching the AP 100.

Here, according to the contention-based scheme such as CSMA/CA, collision may lead to data retransmission of a node which has not received a response message (ACK frame) from the AP 100, and the possibility of occurrence of data collision is increased. Thus, collision spreads and concentration occurs due to data retransmission, temporarily applying a heavy load to the network.

Meanwhile, in case of a smart grid providing an application, such as smart metering, as a major service, uplink traffic is even greater than downlink traffic, so concentration on the AP 100 may take place more severely. Here, among uplink traffic, an association or registration process should be necessarily performed in every node which intends to use a network, so a traffic bottleneck phenomenon of control messages for association or registration may be further increased.

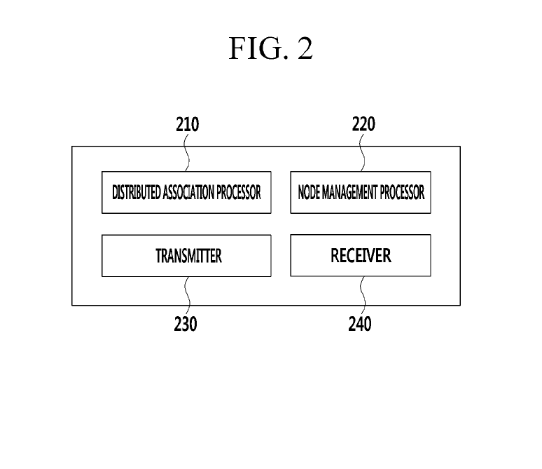

FIG. 2 is a view illustrating an AP according to an embodiment of the present invention.

Referring to FIG. 2, the AP according to an embodiment of the present invention includes a distributed association processor 210, a node management processor 220, a transmitter 230, and a receiver 240.

When the AP determines that nodes included in a wireless network are required to be distributed, the distributed association processor 210 determines a distributed association node to perform distributed association. Here, the distributed association processor 210 may determine a node located in a middle region of the coverage of the AP as a distributed association node.

The node management processor 220 may manage nodes connected to the wireless network through the AP and may manage nodes connected to the wireless network through the distributed association node from the distributed association node.

The transmitter 230 periodically broadcasts a beacon. When the receiver 240 receives an authentication/association request message from a particular node, the receiver 240 may transmit a response message with respect to the authentication/association request message to the particular node. Here, the response message may include an association ID for the particular node to associate the wireless network.

The receiver 240 periodically receives information regarding the node connected to the wireless network through the distribution association node from the distribution association node. Here, the information regarding the node connected to the wireless network through the distributed association node may include a MAC address of the node and an association ID allocated to the node.

Hereinafter, a node management method of an AP and an operation of a general node and a distributed association node included in a network will be described in detail.

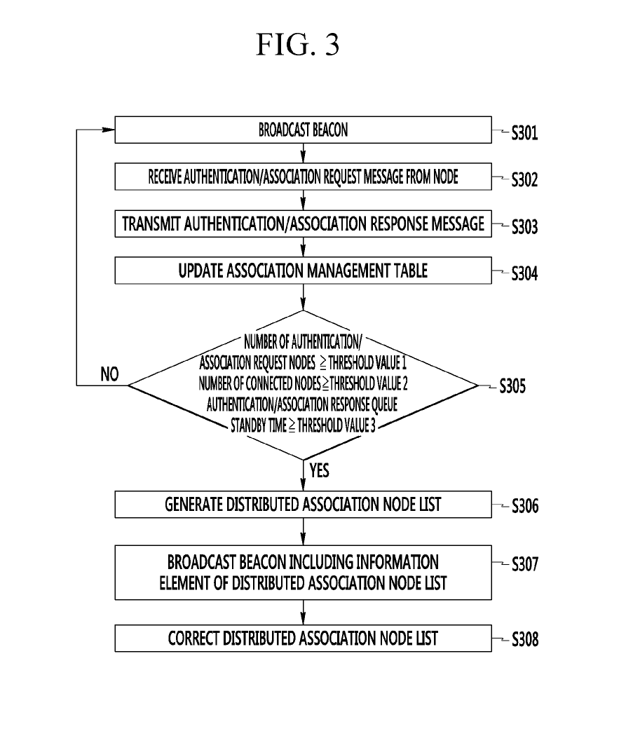

FIG. 3 is a flowchart illustrating a node management process of an AP according to an embodiment of the present invention.

Referring to FIG. 3, first, the AP periodically broadcasts a beacon (S301).

Thereafter, when the AP receives an authentication/association request message from a node (or a node intending to enter the network) among nodes include in the coverage of the AP (S302), the AP transmits a response message to the authentication/association-requested node (S303) to provide an association ID, and updates an association management table (S304).

Thereafter, the AP checks the number of nodes which have requested authentication/association or the number of nodes which have been connected to the AP, or determines whether an authentication/association response queue standby time has reached a threshold value (S305). Here, a threshold value for a node which has requested authentication/association, a threshold value for a node which has already been connected to the AP, or a threshold value for the authentication/association response queue standby time are different (a threshold value 1, a threshold value 2, and a threshold value 3), and each threshold value may be experimentally determined and changed according to a network situation.

When the number of nodes which have requested authentication/association from the AP, the number of nodes which have been connected to the AP, and the authentication/association response queue standby time are all smaller than the threshold values thereof according to the checking, the AP continuously transmits an existing beacon frame.

However, in a case in which at least one of the number of nodes which have requested authentication/association from the AP, the number of nodes which have been connected to the AP, and the authentication/association response queue standby time are equal to or greater than the threshold values, the AP selects a node that may be able to serve as a distributed association node from among the already connected nodes, and generates a distributed association node list (S306).

That is, in a case in which a large number of nodes (nodes equal to or greater than the threshold value 1) have requested authentication/association so associates of the respective nodes are required to be distributed, or in a case in which the number of the nodes which have already been connected reaches the threshold value 2, or in a case in which a standby time of a response queue with respect to authentication/association has reaches the threshold 3, the AP generates a list of nodes to perform distributed association.

Thereafter, the AP includes an information element regarding the distributed association node list in a periodically broadcast beacon, and broadcasts the beacon including the information element regarding the distributed association node list (S307). The information element regarding the distributed association node list will be described in detail with reference to FIG. 3.

Thereafter, the distributed association node list may be corrected according to the transition of the change in the number of the authentication/association requesting nodes, the number of connected nodes, or the authentication/association response queue standby time, so that a distributed association node may be added to or deleted from the distributed association node list (S308).

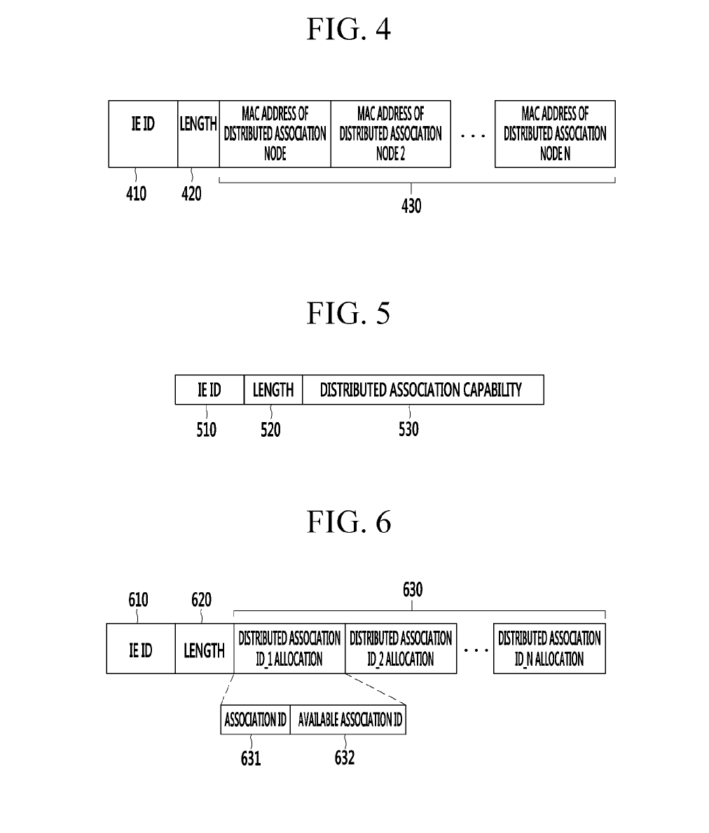

FIG. 4 is a view illustrating an information element regarding a distributed association node list according to an embodiment of the present invention.

Referring to FIG. 4, the information element of the distributed association node list may include an information element ID 410, a length field 420, and a MAC address field 430 of a distributed association node.

The information element ID 410 is an identifier of an information element specifying one of a plurality of information elements included in a beacon.

The length field 420 may express a length of the MAC address field 430 by octets.

The MAC address field 430 is a MAC address of a node operating as a distributed association node. When a node which intends to associate a network is not smoothly connected to the AP, the node may transmit an authentication/association request message to a MAC address of one of a plurality of distributed association nodes written in the MAC address field.

Meanwhile, according to an embodiment of the present invention, the AP may check whether each node is operable as a distributed association node in a process of associating the AP, to thus secure candidates of distributed association nodes in advance. In this case, each node may include an information element regarding capability of a distributed association in an association request message which is transmitted to the AP.

FIG. 5 is a view illustrating an information element regarding a distributed association capability according to an embodiment of the present invention.

Referring to FIG. 4, the information element regarding distributed association capability may include an information element ID 510, a length field 520, and a distributed association capability field 530.

The information element ID 510 and the length field 520 may play the same roles as those of FIG. 4. The distributed association capability field 530 is a field for informing the AP that the node which requests association has capability of being a distributed association node. Thereafter, the AP may utilize the information written in the distributed association capability field 530 in generating a distributed association node list.

FIG. 6 is a view illustrating an information element regarding an association ID according to an embodiment of the present invention.

When broadcasting a beacon including the information element of the distributed association node list, the AP transfers an available association ID to the node included in the distributed association node list. Here, the AP may include the available association ID in a response message with respect to the authentication/association request message transmitted from the distributed association node, may include the available association ID in a periodically broadcast beacon, or may include the available association ID in a separate message such as an announcement message, or the like.

Referring to FIG. 6, the information element regarding an association ID includes an information element ID 610, a length field 620, and a distributed association ID allocation field 630.

The information element ID 610 and the length field 620 may play the same roles as those of the FIGS. 4 and 5. The distributed association ID allocation field 630 includes an association ID subfield 631 and an available association ID subfield 632 of each distributed association node.

The association ID subfield 631 of each distributed association node indicates an ID to be used for a corresponding distributed association node to associate the AP. The available association ID subfield 632 indicates a range of an ID to be allocated to a node that requests authentication/association from the corresponding distributed association node.

According to an embodiment of the present invention, the association ID subfield 631 has a length of 2 octets, in which an association ID of a distributed association node is written, and the available association ID subfield 632 has 4 octets, in which a first ID and the last ID allocatable to the node that requests authentication/association from the corresponding distributed association node are included.

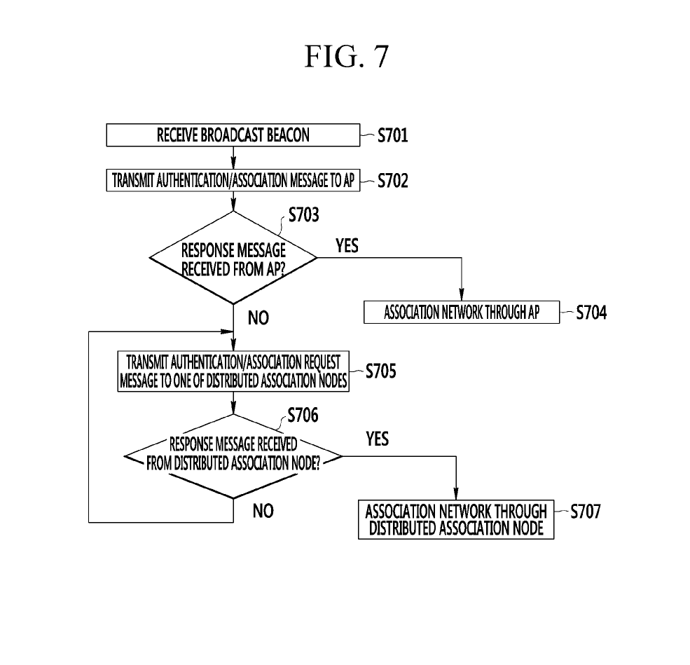

FIG. 7 is a flowchart illustrating a process of requesting authentication/association by a node according to an embodiment of the present invention.

When a node receives a beacon broadcast from the AP (S701), the node transmits an authentication/association request message to the AP which has broadcast the beacon (S702).

Thereafter, the node waits to receive a response message with respect to the authentication/association request message which has been transmitted to the AP (S703). When a response message with respect to the authentication/association request message is received from the AP, the node is connected to (or associated with) the network through the AP (S704). However, when an authentication/association request message is not received from the AP, the node may check an information element of the distributed association node list included in the beacon, and transmits an authentication/association request message to one of distributed association nodes (S705).

When the node receives a response message with respect to the authentication/association request from the distributed association node which has received the authentication/association request message (S706), the node may associate the network by using an available association ID included in the response message (S707).

However, when a response message with respect to the authentication/association request is not received from the distributed association node which has received the authentication/association request message, the node transmits the authentication/association request message to a different distributed association node included in the information element of the distributed association node list (S705).

The node repeatedly performs the foregoing process until a response message with respect to the authentication/association request message is received. Here, if a response message is not received from any distributed association node included in the information element of the distributed association node list, the node determines that network association has failed.

Thereafter, the distributed association node periodically transfers the association ID allocated through the authentication/association request message and a list of ID allocated nodes to the AP. Thereafter, the AP updates an ID management database (DB) with the association ID received from the distributed association node and the association node list, thus recognizing a network association situation.

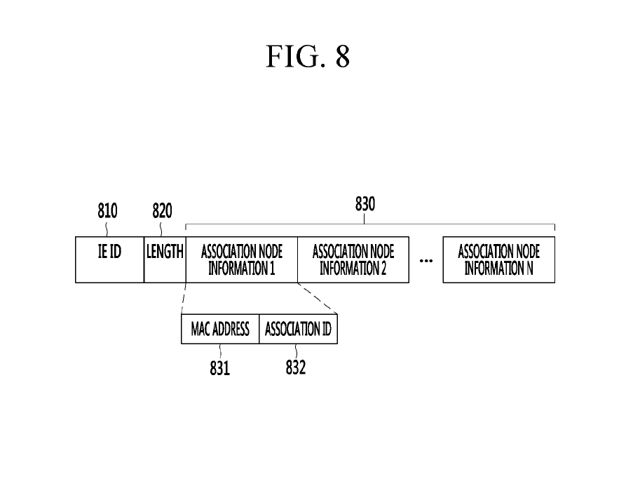

FIG. 8 is a view illustrating an information element regarding a list of connected nodes according to an embodiment of the present invention.

Referring to FIG. 8, an information element regarding a connected node list includes an information ID 810, a length field 820, and an association node information field 830.

The information element ID and the length field are the same as those of FIG. 5, and the association node information field includes a MAC address subfield 831 and an association ID subfield 832.

The MAC address subfield 831 indicates a MAC address of an association node connected to a network through a distributed association node, and the association ID subfield 832 indicates an association ID allocated to an association node by a distributed association node. Here, the association node information field 830 may extend to include detailed information regarding an association node.

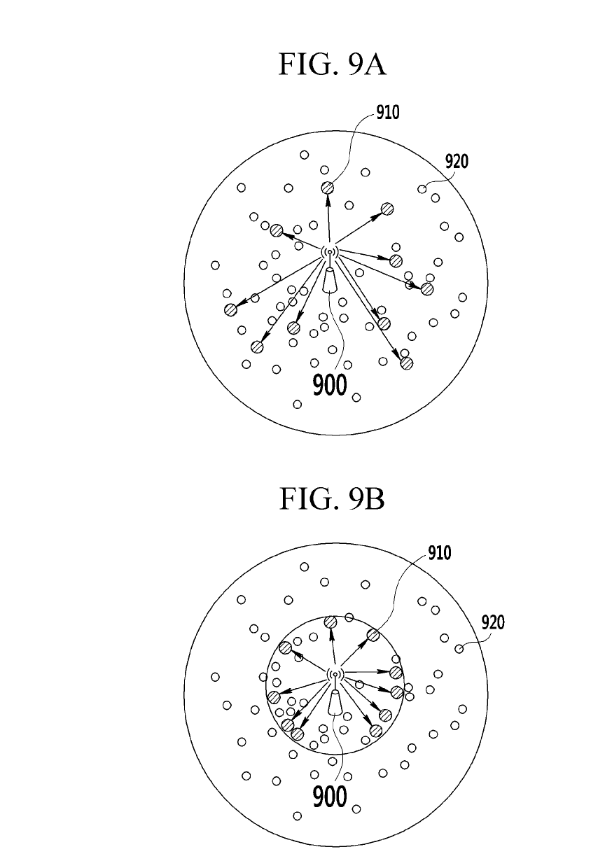

FIGS. 9A and 9B are views illustrating locations of distributed association nodes in a network according to an embodiment of the present invention.

Referring to FIG. 9A, distributed association nodes 910 are located evenly in the entire region of coverage of an AP 900. In this case, since a node 920 connected to the AP 900 through the distributed association node 910 located in the boundary of the coverage of the AP 900 is far from the distributed association node 910 and the AP 900, there is a high possibility of a data transmission and reception error occurring.

Referring to FIG. 9B, the distributed association node 910 is located in the middle region of the coverage of the AP 900. In this case, since all the distributed association nodes 910 are located in the middle region of the coverage of the AP 900, a possibility of a data transmission and reception error occurring is low, and thus all the nodes 920 located in the coverage of the AP 900 may be able to smoothly transmit and receive data.

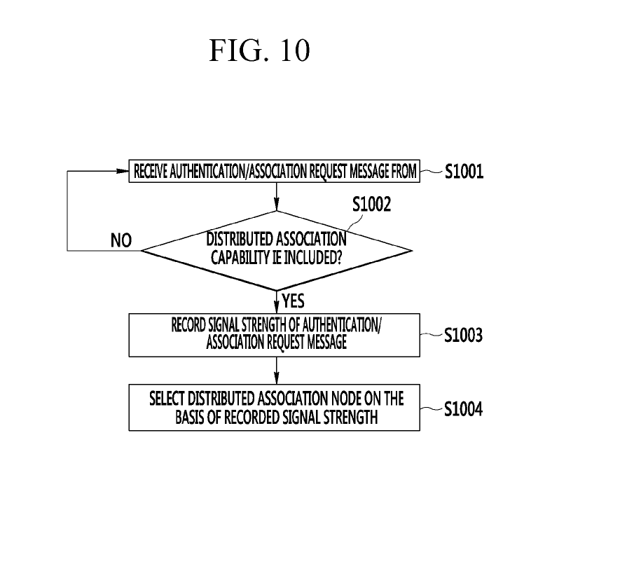

FIG. 10 is a flowchart illustrating a process of generating a list of distributed association nodes by an AP according to an embodiment of the present invention.

Referring to FIG. 10, when an AP receives an authentication/association request message from a node (S1001), the AP determines whether the authentication/association request message includes an information element regarding distributed association capability (S1002).

When the authentication/association request message does not include an information element regarding distributed association capability, the AP continuously waits to receive an authentication/association request message.

However, when an authentication/association request message including an information element regarding distributed association capability is received from a node, the AP records signal strength of the received request message (S1003).

Thereafter, the AP selects a node anticipated to be located in the middle region of the radius of coverage of the AP on the basis of the recorded signal strength, and generates a distributed association node list (S1004).

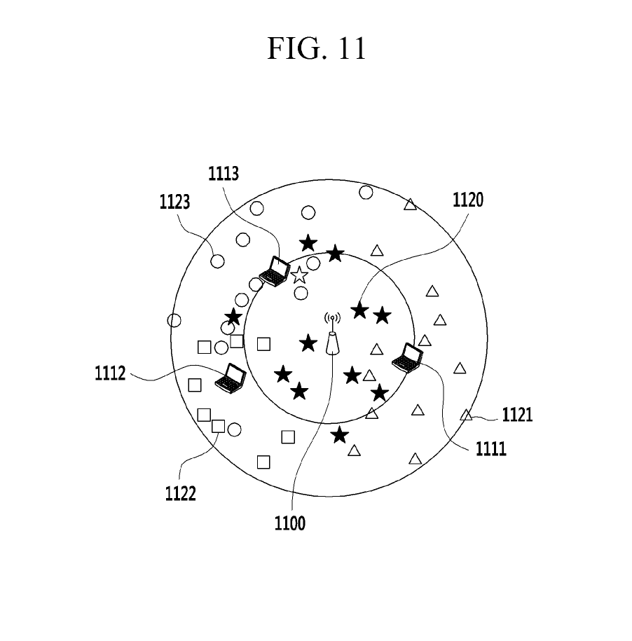

FIG. 11 is a view illustrating nodes connected to a network via the AP and the distributed association nodes according to an embodiment of the present invention.

Referring to FIG. 11, three distributed association nodes 1111 to 1113 are located in the middle region of the coverage of an AP 1100, and an aggregation of a plurality of nodes 1120 to 1123 are located within a radius of the coverage of the AP 1100. All the nodes included in the coverage of the AP 1100 are directly connected to the AP (1120) or connected to distributed association nodes (1121 to 1123).

In FIG. 11, a node aggregation 1 1121 is connected to the distributed association node 1 1111, a node aggregation 2 1122 is connected to a distributed association node 2 1112, and a node aggregation 3 1123 is connected to a distributed association node 3 1113. A node aggregation 4 1120 is directly connected to the AP 1100.

That is, the nodes 1120 located at an inner side of the middle region of the cover of the AP 1100 and located in the vicinity of the middle region of the coverage of the AP 1100 are mainly directly connected to the AP 1100, and the nodes 1121 and 1123 located in the other remaining regions of the coverage of the AP 1100 are mainly connected to the three distributed association nodes 1111 to 1113.

In this manner, according to an embodiment of the present invention, thousands or more nodes included in a wireless network may be connected to the wireless network through a plurality of distributed association nodes, rather than being connected to the wireless network through a single AP, so concentration can be resolved and the wireless network can be effectively operated. Here, since a plurality of nodes located in the middle region of coverage of an AP may be selected as distributed association nodes, a connection failure probability of a node connected to a wireless network through a distributed association node can be reduced, and by performing distributed association on the basis of a single hop, implementation complexity can be lowered.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for managing a plurality of nodes included in coverage of an access point (AP) in a wireless network, the method comprising:
determining a distributed association node to perform distributed association among a plurality of nodes;
including information regarding the distributed association node in a beacon and broadcast the beacon; and
receiving information regarding a node connected to the wireless network through the distributed association node from the distributed association node.

2. The method of claim 1, wherein the determining of a distributed association node comprises:
determining whether a number of first nodes connected to the wireless network through the AP, among the plurality of nodes, is equal to a first threshold value; and
when the number of first nodes is equal to the first threshold value, determining a distributed association node among the plurality of nodes.

3. The method of claim 1, wherein the determining of a distributed association node comprises:
determining whether a number of second nodes that transmit an association request message to the AP is equal to a second threshold value; and
when the number of second nodes is equal to the second threshold value, determining a distributed association node among the plurality of nodes.

4. The method of claim 1, further comprising:
receiving an association request message from a first node among the plurality of nodes; and
transmitting a response message with respect to the association request message to the first node.

5. The method of claim 4, wherein the response message includes an association ID of the wireless network.

6. The method of claim 4, wherein the determining of a distributed association node comprises:
determining whether a reception waiting time of the association request message is equal to a third threshold value; and
when the reception waiting time is equal to the third threshold value, determining a distributed association node among the plurality of nodes.

7. The method of claim 4, wherein the determining of a distributed association node comprises:
extracting information regarding distributed association capability from the association request message; and
determining a distributed association node on the basis of the information regarding the distributed association capability.

8. The method of claim 7, wherein the determining of a distributed association node on the basis of the information regarding the distributed association capability comprises:
recording receive strength of the association request message; and
determining a node estimated to be located in an intermediate region of the coverage on the basis of the receive strength.

9. The method of claim 1, further comprising
after the determining of a distributed association node,
transmitting an association IDentification (ID) and an available association ID of the distributed association node to the determined distributed association node.

10. The method of claim 9, wherein a node connected to the wireless network through the distributed association node associates the wireless network by using the available association ID.

11. The method of claim 10, wherein the receiving comprises
periodically receiving a list of nodes connected to the wireless networks through the distributed association node and an allocation status of available association IDs.

12. A method for a node to associate a wireless network, the method comprising:
receiving a beacon broadcast from an access point (AP) included in a wireless network;
transmitting a first association request message to the AP;
when a first response message with respect to the first association request message is not received from the AP, transmitting a second association request message to a first distributed association node among a plurality of distributed association nodes; and
when a second response message with respect to the second association request message is received from the first distributed association node, associating the wireless network through the first distributed association node.

13. The method of claim 12, further comprising:
when a second response message is not received from the first distributed association node, transmitting a third association request message to a second distributed association node among the plurality of distributed association nodes; and
when a third response message with respect to the third association request message is received from the second distributed association node, associating the wireless network through the second distributed association node.

14. The method of claim 12, wherein the transmitting of the second association request message comprises
determining the first distributed association node upon recognition of media access control (MAC) addresses of a plurality of distributed association nodes written in a beacon.

15. The method of claim 12, wherein associating of the wireless network comprises
associating the wireless network through the first distributed association node by using an available association ID included in the second response message.

16. An access point (AP) device that manages a plurality of nodes included in a wireless network, the AP device comprising:
a distributed association processor configured to determine a distributed association node to perform distributed association among a plurality of nodes;
a transmitter configured to include information regarding the distributed association node in a beacon and broadcast the beacon; and
a receiver configured to receive information regarding a node connected to the wireless network through the distributed association node among the plurality of nodes, from the distributed association node.

17. The AP device of claim 16, wherein the receiver receives an association request message from a first node among the plurality of nodes, and
the distributed association processor extracts information regarding distributed association capability from the association request message, and determines a distributed association node on the basis of the information regarding distributed association capability.

18. The AP device of claim 17, wherein the transmitter transmits a response with respect to the association request message, and
the response message includes an association ID of the wireless network.

19. The AP device of claim 17, wherein the distributed association processor determines a node estimated to be located in the middle region of coverage of the AP device on the basis of receive strength of the association request message, as a distributed association node.

20. The AP device of claim 16, wherein the transmitter transmits an association identification (ID) and an available association ID of the distributed association node to the distributed association node.
